(19) United States
(12) Patent Application Publication
(10) Pub. No.: US 2015/0339415 A1
(43) Pub. Date: Nov. 26, 2015

(54) SYSTEM AND METHOD FOR CREATING A SIMULATION MODEL VIA CROWDSOURCING

(71) Applicants: Gary L. KLEIN, Reston, VA (US); Craig A. BONACETO, Chelmsford, MA (US); Jill L. DRURY, Nashua, NH (US); Mark S. PFAFF, Indianapolis, IN (US)

(72) Inventors: Gary L. KLEIN, Reston, VA (US); Craig A. BONACETO, Chelmsford, MA (US); Jill L. DRURY, Nashua, NH (US); Mark S. PFAFF, Indianapolis, IN (US)

(21) Appl. No.: 14/284,167

(22) Filed: May 21, 2014

(51) Int. Cl. G06F 17/50

(52) U.S. Cl. CPC G06F 17/5009

(57) ABSTRACT

The disclosed systems and methods transform descriptive causal models into digital computer simulation models based on information obtained from crowdsourcing. This may include interviewing experts to collect descriptive information that is used to assemble causal descriptive models, which can be represented as graphs of nodes connected by edges. Node values may represent concepts and edge weights represent their causal relationships. Crowdsourcing is used to collect feedback about the causal descriptive models. The feedback is used to calculate edge weights that are incorporated into causal simulation models for use during model processing runs. A digital computer simulation is completed when node values reach steady states after model processing runs. A computer visualization tool can then be used to analyze outcome spaces produced by digital computer simulations. For example, digital computer simulations can generate decision spaces that are used to determine preferable courses of action in different situations.

### FIELD OF THE INVENTION

This invention relates to systems and methods for transforming causal descriptive models into digital computer simulation models based on information obtained from crowdsourcing. In particular, feedback obtained from crowdsourcing is used to quantify the strength of causal relationships between variables in descriptive models to provide an unbiased distribution of estimated values for each causal relationship and thereby enable mathematically processing the descriptive models on a computer.

### BACKGROUND OF THE INVENTION

There is an increasing interest in creating digital computer simulations of real-world systems. For example, alternative courses of action can be evaluated using a digital computer simulation, which can provide decision makers with decision support during real-world emergency situations, such as a natural disaster. Digital computer simulations are emulations of real-world systems or processes.

Conventional computer simulation systems include models that are designed based on expert knowledge for use to simulate different situations that may occur in the real-world. These computer simulations are assumed to be reliable because they are created using expert knowledge. Unfortunately, each expert has certain behavioral patterns, preferences and characteristics that may bias the programming of models. For example, different experts may agree to include certain variables in a particular computer model but disagree about the significance of each variable. Thus, conventional computer simulations created using expert models may be biased and unreliable.

Moreover, the process of translating expert knowledge into computer simulation models can be slow and error prone. This occurs because the knowledge must be translated from a mental representation familiar to the experts into executable code written in a computer language. This most often requires computer programmers to do this translation. The process is slow because the translation must be carefully and constantly validated by the experts to eliminate errors resulting from translating. Further, the experts must verify programming code to ensure that syntactical errors in computer language have not been introduced.

Crowdsourcing is a process of obtaining services, ideas, or content by soliciting contributions, especially over the Internet, from a large group of people referred to as a crowd. This process typically involves a division of labor for tedious tasks split among members of the crowd. For example, crowdsourcing can be used to solicit predictions for a political campaign, or to search for answers, solutions or a missing person. In other words, crowdsourcing combines the incremental efforts of numerous contributors to achieve a greater result in a relatively short period of time.

### SUMMARY OF THE INVENTION

The disclosed systems and methods transform descriptive causal models into digital computer simulation models based on information obtained from crowdsourcing. A computer user interface for crowdsourcing, combined with computational algorithms, produce quantitative values for the strengths of causal relationships between variables in the descriptive models, resulting in unbiased distributions of estimated values for each relationship, and enabling the models to be processed on one or more computers. The disclosed systems and methods generate improved outcome spaces, which refer to one or more possibilities regarding the relationships among options, actions or variables that can be used to analyze the subject of a computer model. For example, a decision space can be an outcome space used by decision makers to determine how to respond to an emergency situation based on the relationships between options and their plausible effects that can be forecasted by a computer simulation from facts about the situation.

In some embodiments, experts may provide information that is used to create a canonical descriptive causal model that is represented in a digital data structure, which refers to a model that includes data common to the information provided by the experts. The models may include variables identified by the experts. Crowdsourcing is then used to define causal associations between the variables in the descriptive causal model. Crowdsourcing may include soliciting paid or unpaid feedback, over the Internet, through a number of client computer devices. The feedback is used to calculate weights that represent causal associations between the variables. A digital computer simulation processing of causal simulation models is a transformation that then generates one or more outcome spaces.

An expert's descriptive causal model can be elicited, and then represented in a digital data structure that is interpretable by computer programs and, moreover, can be displayed in a graphical presentation that is easy for the expert to validate. The descriptive causal model can be represented on a computer as a graph of nodes connected by edges, as shown in FIG. 2, as detailed below. A node represents a variable concept and an edge represents a causal relationship between nodes. Each node may be associated with a value that indicates its significance or preference, and each edge may be associated with a weight. The weight includes a value with a magnitude that may be positive or negative. The direction of the correlation between nodes may be denoted with a positive or negative sign, and the magnitude may denote the strength of the causal relationship between nodes. A distribution of values for the edge weights can be determined through crowdsourcing. An algorithm can be used to determine how crowd sourced feedback defines the distribution of edge weights.

The disclosed systems and methods do not require human translation of a descriptive model into a computer language to produce a simulation model, and therefore translation errors and translation time are minimized or avoided. Because crowdsourcing provides such a quick method for constructing simulation models, these models can be used to support decision making in a more timely fashion than traditional simulation development methods, and therefore under more urgent conditions.

Node values and edges of a model may be represented by one or more data structures. Processing the model may involve applying a calculation engine to these structures. In processing the model, the node values and edge weights may be initialized prior to a simulation analysis, which may include multiple model processing runs. A model processing run can be multiple iterations of processing the model on a computer. Node values may change on each iteration of a single model processing run. On the other hand, edge weights are usually held constant during single model processing runs. Across multiple model processing runs, edge weights may be set to different values sampled from a crowd-sourced distribution. In this way, the sensitivity of the descriptive model to various combinations of node values and edge weights can be computationally evaluated.

One use of such quantified causal simulation models is to calculate outcome spaces using a computer. For each run, a distribution of values for each outcome node (i.e., an end-state node of the causal model) can be generated by varying values and/or edge weights for the initial nodes (i.e., an initial-state node of the causal model), and processing the causal simulation model for each variation. Variations may be generated by, for example, using a Monte-Carlo method where each variation is generated by sampling from distributions of values for nodes and/or edges, or using a Cartesian Product method where every possible combination of values is generated. An outcome space is generated from a total number of causal simulation model processing runs, associating outcome values with initial values. The setting of the initial values may represent different options for courses of action, or environmental conditions. In this way, analysis of an outcome space can yield better understanding of the impact of variables in the model on the distribution of outcomes. For example, different options for courses of action can be compared based on their calculated outcomes as determined by a causal simulation model.

In some embodiments, a computer implemented method for creating a causal computer simulation includes creating one or more causal descriptive models, each causal descriptive model includes nodes associated with weights. The method also includes generating, using one or more processors, one or more groups including two or more of the nodes, receiving, over a network, feedback from users about each group, determining values for the weights based on the feedback, and processing the one or more causal descriptive models to create a causal computer simulation. In some embodiments, each causal descriptive model includes nodes associated with only qualitative weights, and the values determined for the weights based on the feedback are quantitative values.

In some embodiments, the method includes determining the values by crowdsourcing with the users. In some embodiments, each of the users is registered with a website that accepts the feedback. In some embodiments, registering a user with the website includes storing information in a memory received from the user that includes keywords and credentials that indicate a type and level of expertise for the user.

In some embodiments, the method includes soliciting feedback for a group, over a network, from a registered user with a type and level of expertise that is equal to or greater than a type and level of expertise associated with the group. In some embodiments, a registered user is permitted to provide feedback for a group only when the registered user has a type and level of expertise that is equal to or greater than a type and level of expertise associated with the group or with at least one of the causal descriptive models.

In some embodiments, the method includes generating a distribution of values for each of the weights based on the feedback received from the crowdsourcing. In some embodiments, the method includes designating a value for each of the weights by sampling from the respective distribution of values for each of the respective weights. In some embodiments, the method includes designating a value for each of the weights by calculating an average value from the respective distribution of values for each of the respective weights.

In some embodiments, the method includes setting one or more initial values for at least a portion of the nodes, and changing the one or more initial values during the causal computer simulation processing. In some embodiments, the method includes iterating model processing runs of the one or more causal descriptive models during the causal computer simulation processing until values for the at least a portion of the nodes are within a predetermined threshold difference between N+1 and N iterations. The threshold may be zero.

In some embodiments, the method includes iterating model processing runs of the one or more causal descriptive models during the causal computer simulation processing until values for the at least a portion of the nodes converge. In some embodiments, each of the nodes is associated with keywords and two or more nodes are included in a group when they are associated with at least one common keyword. In some embodiments, each of the two or more groups consists of two nodes.

In some embodiments, an apparatus for creating a digital computer simulation includes one or more processors configured to determine two or more groups that each include two or more nodes that are extracted from one or more causal descriptive models and associated with weights. The apparatus also includes a network interface configured to receive, over a network, feedback about each group from users, and a memory configured to store values determined for the weights from the feedback, the one or more processors algorithmically process the one or more causal descriptive models to create a digital computer simulation.

In some embodiments, the one or more processors generate a distribution of values for each of the weights based on feedback received by crowdsourcing with the users. In some embodiments, the one or more processors designate a value for each of the weights by sampling from the respective distribution of values for each of the respective weights. In some embodiments, the one or more processors designate a value for each of the weights by calculating an average value from the respective distribution of values for each of the respective weights.

In some embodiments, a server system for creating a digital computer simulation includes a network interface configured to receive, over a network, feedback from users about causal relationship between nodes in one or more causal descriptive models, and one or more processors configured to calculate values associated with the causal relationships and process the one or more causal descriptive models to create a digital computer simulation.

In some embodiments, the server system includes one or more memories configured to store registration information for each of the users that includes keywords and credentials that indicate a type and level of expertise for each user. In some embodiments, a registered user is permitted to provide feedback for a group only when the registered user has a type and level of expertise that is equal to or greater than a type and level of expertise associated with the group. In some embodiments, the feedback is solicited, over the network, for a group from a registered user with a type and level of expertise that is equal to or greater than a type and level of expertise associated with the group.

### BRIEF DESCRIPTION OF THE DRAWINGS

FIG. 1 shows a system that includes computer components connected over a network, according to some embodiments of the invention;

FIG. 2 shows a directed acyclic graph of a causal descriptive model that can be represented as data structures and displayed on a display of a computer, according to some embodiments of the invention;

FIG. 3 shows a flowchart illustrating a process for creating a canonical descriptive causal model, according to some embodiments of the invention;

FIG. 4 shows an example of a causal descriptive model that addresses relationships between electric cars purchased by consumers and gas cars purchased by consumers, according to some embodiments of the invention;

FIG. 5 shows a flowchart illustrating a process for generating edge weights via crowdsourcing over a computer network, resulting in a causal simulation model, according to some embodiments of the invention;

FIG. 6A-6C illustrate various exemplary display screens of a user interface used to elicit feedback via crowdsourcing over a computer network, according to some embodiments of the invention;

FIG. 7 shows a flowchart illustrating a computer process for generating an outcome space, according to some embodiments of the invention; and

FIG. 8 illustrates a user interface used for exploring an outcome space, according to some embodiments of the invention.

### DETAILED DESCRIPTION OF THE INVENTION

Described are systems and methods for transforming causal descriptive models into digital computer simulation models based on feedback received by crowdsourcing over a network. A digital computer simulation can be used to analyze a subject, as one or more descriptive causal models that can be represented as graphs of nodes connected by edges in a data structure that is interpretable by a computer program, and rendered on a computer display. For example, a subject of a digital computer simulation may be consumer interest in electric cars.

A node in a descriptive model is a variable that represents a concept such as an action, option or policy that has a range of values. An edge includes a weight that represents a causal association or relationship between two or more nodes. The sign of an edge weight denotes a direction of correlation between nodes, and the magnitude of an edge weight denotes the strength of the causal relationship between the nodes. In some embodiments, digital computer simulations can be based on common concepts drawn from a group of people, such as experts, to describe and represent how the world is commonly understood by the experts. In the example of consumer interest in electric cars, a descriptive causal model may include nodes that represent variables such as the number of charging stations and convenience of electric cars. An edge between these nodes with a value of +1 may indicate strong positive causality between the number of charging stations and electric car convenience, where an increase in charging stations results in an increase in convenience.

Node values may be initialized with known or default values. Edge weights can be defined based on feedback received from crowdsourcing over a network. Edge weights are initialized, as determined through crowdsourcing, and are usually held constant during each simulation model processing run. Edge weights could be initialized to an average crowd-sourced value or by sampling values from a crowd sourced distribution. Simulation modeling and crowdsourcing are used herein in a manner that exploits their benefits to provide reliable and unbiased digital computer simulations in a quick and efficient manner. In the example of consumer interest in electric cars, an initial value representing the importance of charging stations may be known and input into the model. Crowdsourcing can be used to determine a degree of perceived causality between charging stations and electric car convenience, for example.

Multiple simulation model processing runs can be iterated to generate one or more outcome spaces. Initial node values and edge weights can be varied for each model processing run to create an outcome node distribution. Variations may be generated in different ways. For example, a Monte-Carlo method can be used to generate each variation by sampling from distributions of node values and edge weights. As another example, a Cartesian Product method can be used to generate every possible variation of node values and edge weights that can be used to execute multiple model processing runs to generate outcome spaces. For node values and edge weights that have a distribution of values, each node value and/or edge weight in the distributions can be sampled. An outcome space is then generated from a total number of model processing runs that is determined based on variables including a number of options, environmental conditions, as represented in node values and edge weights, as detailed below. In the example of consumer interest in electric cars, different values for number of electric car charging stations, and the associated causality, can be used for each model processing run to generate a distribution of values for electric car convenience and ultimately the number of electric cars that consumers purchase. An analysis of the resulting outcome space provides a more comprehensive understanding about how various variables impact consumer interest in electric cars.

A computer simulation of causal models is processed to generate an outcome space that can be used to assess a real-world system or process. The values of some nodes may change during a model processing run to generate the outcome space. A digital computer simulation can be complete when, for example, outcome nodes of causal simulation models reach steady state values, or after a specified number of iterations model processing. The outcome space can be viewed and explored graphically by using a computer visualization tool. In the example of consumer interest in electric cars, an outcome space may include two outcome nodes, which represent the number of electric cars or gas cars purchased by consumers, respectively.

### A. System

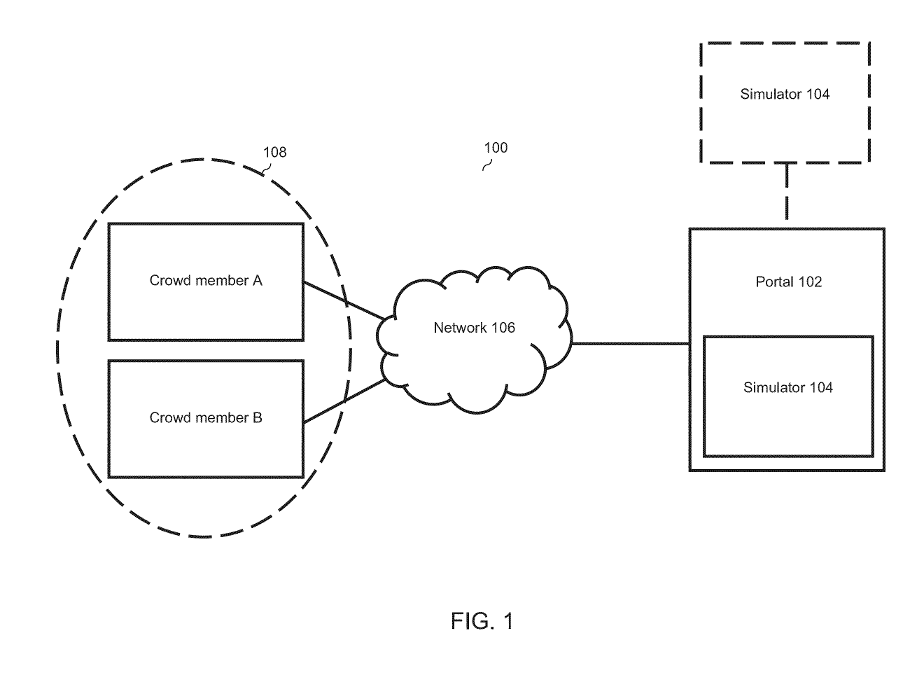

The inventions described herein can be or include components of system 100, as shown in FIG. 1. System 100 includes portal 102 and simulator 104, which may reside on the same or different servers (also shown), may be distributed across multiple servers, or combinations thereof. Simulator 104 communicates through portal 102 to two or more crowd members 108 over network 106. For the sake of brevity, FIG. 1 only shows two crowd members 108, member A and member B. A crowd member, as referred to in the context of system 100, may be a client-side computing device or machine operated by a user. System 100 may include an unlimited number of crowd members, which may provide feedback to simulator 104 through portal 102 by using the same or different hardware and software components. From the perspective of crowd members 108, portal 102 may correspond to an IP address, URL, website or other source of connection to simulator 104. From the perspective of portal 102, crowd members 108 may correspond to user identifications or any data string that represents a person or entity. Crowd members 108 provide information, input and/or feedback about a causal simulation model that can be used in a variety of ways to define and refine the model.

Portal 102 and/or simulator 104 may include one or more databases (not shown) that are used to store received information, input and/or feedback from crowd members 108 about one or more causal simulation models. The databases may store information including registered users and their type and level of expertise, historical information about their contributions to models, and the like. For example, the databases may include user names, passwords, and demographic information. The databases may also include information about user expertise and credentials, such as years of work experience, type and number of academic degrees, peer ratings, and the like. The users of crowd members 108 may be registered with portal 102 or simply known by but not registered with portal 102. In some embodiments, the devices operated by users that comprise crowd members 108 may be registered with portal 102 and/or simulator 104.

Crowd members 108 may communicate with portal 102 over network 106, such as the Internet. Portal 102 may be or include one or more web servers that provide a graphical user interface to crowd members 108. Other communications technologies that may be used by crowd members 108 may include, but are not limited to, any combination of wired or wireless digital or analog communications channels. These communications technologies can include Ethernet, Wi-Fi, BLUETOOTH, and other wireless technologies. Network 106 can include, for example, the Internet, a local area network (LAN), a wide area network (WAN), a cellular phone network, or the like, and combinations thereof.

Portal 102, simulator 104 and crowd members 108 can include one or more servers, devices, wired or wireless machines, or combinations thereof, for sending and receiving data. For example, portal 102 may include an appliance, and each crowd member (e.g., A and B) of crowd members 108 may include any portable device, such as a personal computer, laptop computer or smartphone. In some embodiments, these devices may be configured to send and receive voice or data through the Internet, a cellular network, web browser, dedicated applications, or the like.

Portal 102 and crowd members 108 can be or can include computers running any version of LINUX, UNIX, MICROSOFT WINDOWS, MAC OS, GOOGLE CHROME, or another operating system or platform. Portal 102 and crowd members 108, and components residing therein, may include a communications interface. A communication interface may allow direct connections, or over network 106, to other devices, servers, or the like. In some embodiments, a crowd member can be connected to other crowd member devices or device via a communications interface. Under control of an OS, application programs that run on portal 102 or crowd members 108 exchange commands and data with external sources, via a network connection or USB connection to transmit and receive information during execution of portal 102 or crowd members 108.

As shown in FIG. 1, portal 102 facilitate collecting information from crowd members 108. Simulator 104 can then use the collected information to compute node values and/or edge weights of a causal simulation model. In some embodiments, portal 102 is a web portal that includes a website that stores a library of causal simulation models and user information that can be used by simulator 104 for model processing runs. In some embodiments, users with a particular type and level of expertise can only access or provide information for models with matching expertise type and level. In some embodiments, simulator 104 identifies users with a particular type and level of expertise that is equal to or less than the type and level of expertise associated with a model. Portal 102 then solicits the identified users over network 106 for feedback about the model.

Simulator 104 can receive, collect and analyze crowd sourced information on a regular or periodic basis, to generate and refine causal simulation models. In some embodiments, components of portal 102 or crowd members 108 may be distributed across several servers, mobile devices, or combinations thereof. These devices may each include an input interface, processor, memory, communications interface, output interface, or combinations thereof, interconnected by a bus. The memory in these components may include volatile and non-volatile storage. For example, memory storage may include solid-state drives (SSD), read only memory (ROM) in hard disk devices (HDD), random access memory (RAM), and the like. The OS and application programs of these devices may be stored on SSD.

As shown in FIG. 1, information from and about crowd members 108 is collected over network 106, through another networked facility, or from a dedicated input source, or combinations thereof. The devices housing portal 102 or crowd members 108 may be connected to input devices, such as a keyboard or mouse. A display such as a conventional color monitor, and a printer such as a conventional laser printer, may also be connected to output interfaces. The output interfaces provide requisite circuitry to electrically connect and interface the display and printer to the devices housing portal 102 or crowd members 108. Through these input and output devices, a user can access and install applications on portal 102 or crowd members 108.

Portions of system 100 may be embodied on a distributed processing system to break processing apart into smaller jobs that are executed by different processors in parallel. The results of the parallel processing could be assembled once completed. In some embodiments, features of portal 102 can be provided to system 100 as a subscribed service.

Program modules that implement portal 102 and/or simulator 104 may be incorporated into a network appliance. The program modules may execute under control of an OS, as detailed above. When embodied as an appliance, portal 102 and simulator 104 can operate in a manner that is substantially, or totally, transparent to crowd members 108. In some embodiments, portal 102 and simulator 104 could be embodied as tools that run on any JAVA enabled platform. In some embodiments, portal 102 is implemented in JAVA.

In some embodiments, aspects of system 100, including computer modules that comprise portal 102, simulator 104, or crowd members 108 may be stored on non-transitory computer readable mediums. The instructions that comprise the program modules can be executed by CPUs on portal 102, simulator 104, crowd members 108, or combinations thereof. In some embodiments, different computer modules executed by portal 102, simulator 104, or crowd members 108 can be executed across multiple computing devices or all executed at the same device. For example, a visualization tool may be accessible on any of portal 102, simulator 104, or crowd members 108. In some embodiments, simulator 104 may reside on a client device of crowd members 108.

Portal 102 or crowd members 108 can execute on servers that provide websites for administrators to access these servers over network 106. Anyone with proper access rights to portal 102 can connect to, and use, visualization tools provided thereby. These components can run on any type of server, including virtual servers or actual machines, and can be designed to operate in any computing environment because they have few requirements for underlying hardware and operating systems.

### B. Causal Simulation Models

Simulation modeling includes a process of creating and analyzing a computer model of a system or process to forecast real world outcomes under different possible conditions. The system or process may include subjects, issues, actions, and the like, represented as variable values. Simulation modeling can be used to help people understand whether, under what conditions, and in which ways one variable influences another variable to generate a desired or undesired outcome. Simulation modeling can facilitate, for example, decision-making in a complex world where the simulated system includes numerous variables that are interconnected in an intricate manner.

A causal simulation model describes causal mechanisms of a system or process. A digital computer program can process the model to determine one or more outcome spaces, which correspond to possible outcomes of a causal simulation model. All possible outcomes of a simulation form elements of an outcome space. In the context of providing decision support, an outcome space that characterizes the relationships between courses of action and outcome values corresponds to a decision space. A causal simulation model may be based on a canonical descriptive model that includes variables and relationships that are commonly identified by two or more people, such as experts.

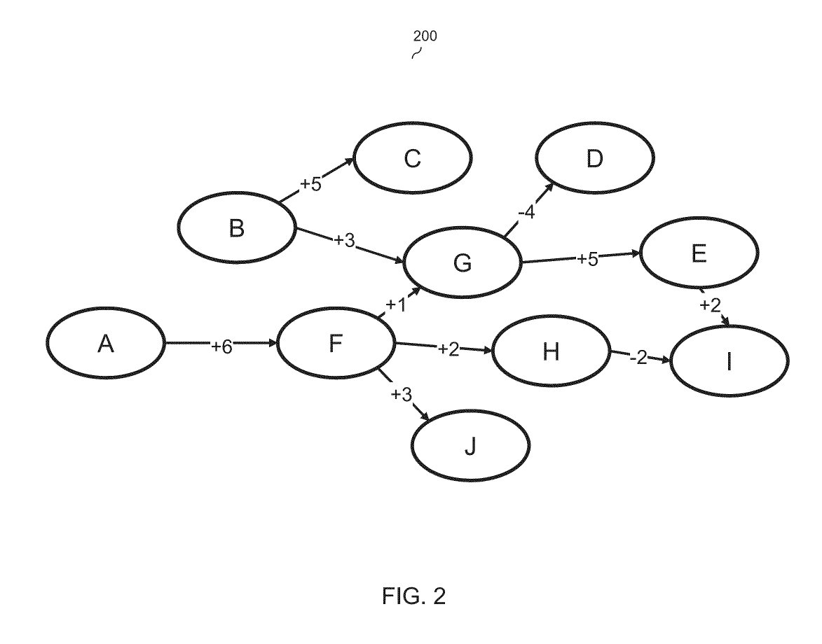

A causal descriptive model can be rendered as a directed acyclic graph (DAG) 200, as shown in FIG. 2. The DAG may include two or more nodes and one or more edges that connect the nodes. A collection of models or subsets thereof can be integrated into one or more causal descriptive models. For example, a single consensus model can incorporate two or more expert causal descriptive models. To harmonize multiple models into a single consensus model, an algorithm could be used to find union sets of edges across models and generate comparisons using those edges. For example, FIG. 2 shows a DAG that includes variables A through J, which are represented as respective nodes. Each node is connected to one or more other nodes by edges that are associated with weights. An edge includes a direction of causality shown by an arrow, for example. An edge weight includes a magnitude that is shown by a number and a correlation type (increase or decrease) that is shown by a plus or minus sign respectively. The weight represents a type and strength of causality between two nodes. For example, node F has a direct cause on node G, which has an inverse cause on node D. Moreover, the direct cause of node F on G is less than the inverse cause of G on D.

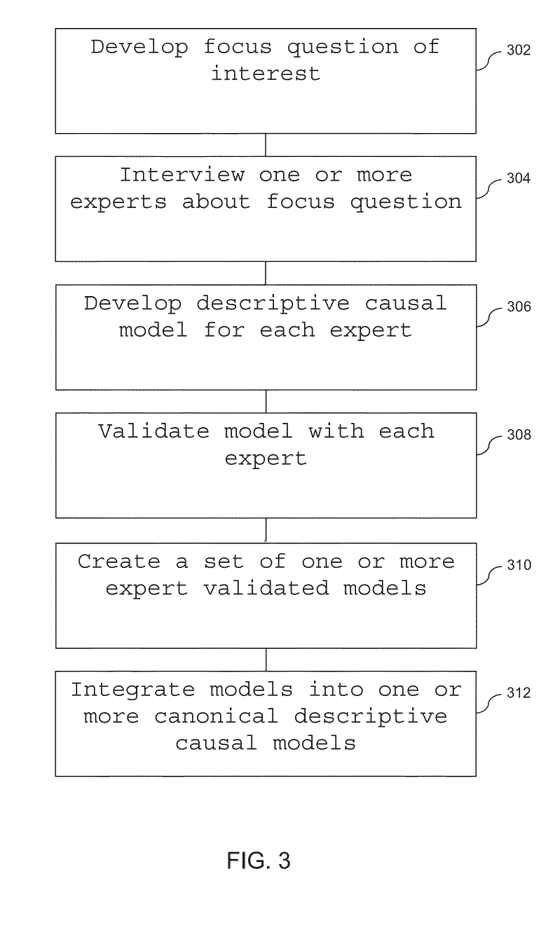

FIG. 3 shows a flowchart illustrating a process for creating a canonical descriptive causal model. In step 302, a focus question is developed. The focus question can include the subject of interest that includes variables used to assemble a canonical descriptive model. For example, a focus question may be, “Will Iran invade the Strait of Hormuz by December 2014?” Another example is, “Will consumers buy more electric vehicles than gas vehicles in 2018.” In step 304, one or more members of a group are interviewed about the focus question. In this example, the members are experts in the subject of the focus question. In step 306, a computer model may be developed based on each expert interview. A representative graphical format may be a fuzzy cognitive map similar to the nodes connected by edges in FIG. 2. In step 308, each assembled model can be validated by respective experts, or other experts. In step 310, a set of one or more descriptive models that have been validated by experts are assembled. In step 312, one or more descriptive models can be integrated into one or more canonical descriptive models for use in model processing runs. In some embodiments, any one or more of the steps shown in FIG. 3 can be integrated into a web-based crowdsourcing system. For example, the process of conducting interviews and manually creating a canonical descriptive model can be conducted via crowdsourcing.

In some embodiments, canonical descriptive models can be created from information obtained from one or more sources. For example, one or more experts of a real system may be interviewed to collect information that is used to create a canonical descriptive model of the real system. The information can be collected from a cohort of experts through a methodical interview process. A particular group of experts of a specific subject can be interviewed for their opinions about variables and relationships there-between to create a canonical descriptive model that forms the basis of a causal simulation model processed during digital computer simulation. A canonical descriptive model refers to including common information from each expert in a group of experts. Thus, a model can be generated for each expert interview, or one canonical descriptive model generated based on more than one expert interview. In some embodiments, the information used as a basis for a digital computer simulation could be collected by conducting research without interviewing experts. In some embodiments, the collected information could be obtained from non-experts to identify beliefs that may be faulty.

In some embodiments, a causal descriptive model can be created in a two-phase process. The first phase includes creating a model based on descriptive information. For example, as detailed above, a representative cohort of individuals can be interviewed to obtain and validate a set of models. The information obtained from the interviews can be coded by one or more independent coders and then validated by an analysis team. From these coded interviews, the analysis team can identify canonical descriptive models shared by groups within the cohort. In the second phase, canonical descriptive models are used as a basis for a computer-automated survey of a broader sampling of a population through crowdsourcing. Causal descriptive models can then be represented as a DAG shown in FIG. 2, although the exact form may dependent on the actual models derived from the interviews and crowdsourcing. Using visualizations of these causal descriptive models, such as a DAG, individuals can select a model that matches their expertise or network of beliefs.

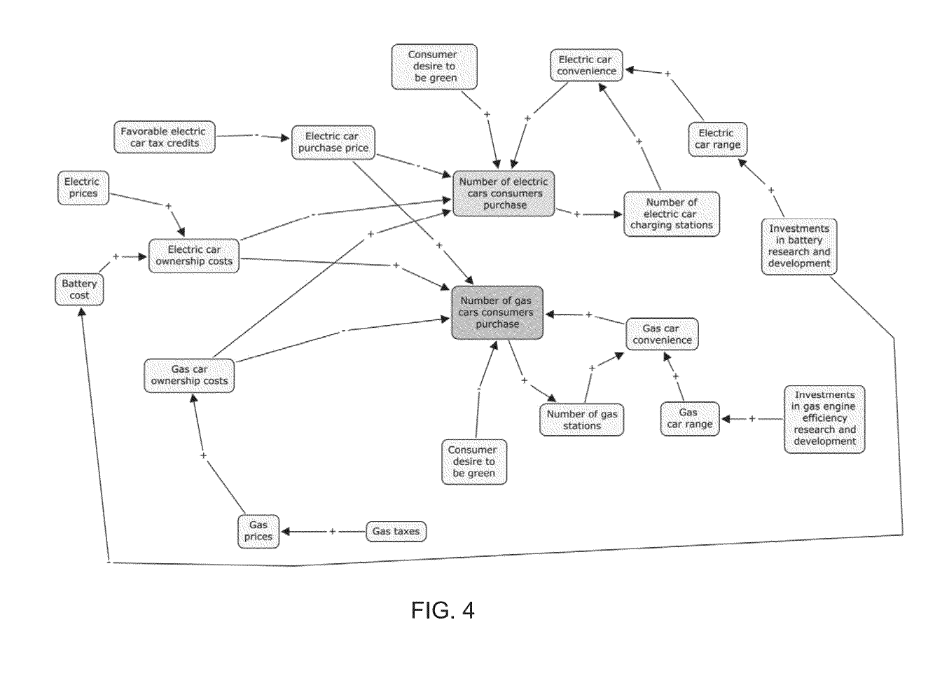

FIG. 4 shows a specific example of a causal descriptive model of a focus question: “Will consumers buy more electric vehicles than gas vehicles in 2018.” Experts may be interviewed to identify variables depicted in FIG. 4 as nodes, which include factors that influence consumers to purchase gas cars over electric cars, such as “consumer desire to be green” and “gas car convenience.” Notably, these factors have different impacts on decisions by consumers to purchase gas cars over electric cars. Although not shown in FIG. 4, the edges can include weights to show the relative magnitudes that factors have on influencing consumers to purchase either an electric or gas car.

In some embodiments, when causal descriptive models are evaluated by a population of individuals via crowdsourcing, a number of analyses and functions become possible. For example, a divergence in beliefs between individuals can be calculated with regard to values that they assigned to any subset of N edges. Based on this calculation, an evaluative feedback space can be generated that allows an individual to see their relationship to members of social groups who have also evaluated the edges of the model. For example, different employee seniority levels (e.g., 3, 4 or 5) can be shown in an evaluative feedback space. The evaluative measure, models of members of XYZ team can differ substantially across seniority levels. Within seniority levels 3 and 5, for example, there may be even greater differences among the XYZ team members.

In some embodiments, the evaluative feedback system can maintain permanent anonymous links between individuals and their models. These links can allow for sending messages directly to individuals while maintaining anonymity. For example, anonymous individuals can be selected for a causal descriptive model, any combination of edge evaluations, or social group (e.g., team or seniority) to receive specific messages crafted to address their beliefs. In this way, messages can be tailored to address individual beliefs without identifying specific individuals. In addition, it is possible to perform a controlled evaluation of the effectiveness of different messages. Variations on messages can even be sent to subgroups to compare their effects on beliefs expressed in the causal descriptive models.

### C. Nodes and Edges

As shown in FIG. 2, a model can be represented as a directed acyclic graph (DAG) that includes nodes connected by edges. A node is a variable with a value that is known or unknown, and in simulation processing may vary or be held constant. For example, a node can represent a concept such as an action, policy, rule, or the like. In some embodiments, a node value may be Boolean in nature. For example, nodes may represent a concept as true, false, or null with a value of +1, −1, or 0, respectively. A node value can be discrete, finite, infinite, or include any combination of numbers or characters. For example, a node value can range as a decimal or fractional value between −1.00 to +1.00. Node values may also represent changes in a concept. For example, +1 may indicates a high or increased change in a concept represented by the node, 0 may indicate a nominal change in the concept, and −1 may indicates a low or decreased change.

As detailed above, one or more persons (e.g., experts) may identify concepts and their values, which can be included as nodes in causal descriptive models. In some embodiments, at least some crowd members 108 can identify some nodes and/or their values through portal 102 that can be used by simulator 104 during model processing runs. As detailed below, nodes can include initial values for one or more model processing runs, which are provided by one or more persons, or through crowdsourcing.

Nodes can be broadly categorized as, but not limited to, outcome, status, and choice nodes. Outcome nodes are dependent variables that represent outcomes of interest. Outcome nodes may be discrete quantities, continuously variable quantities, Boolean, or the like. Outcome nodes form an outcome space and their respective values may be generated by execution as a digital computer simulation. For example, outcome nodes form an outcome space after completing a number of iterative model processing runs to obtain steady state node values. An example of an outcome node in a warfare context includes “North Korea launches rocket.” In FIG. 4, outcome nodes include the “number of electric cars consumers purchase” and the “number of gas cars consumers purchase.”

Status nodes are intermediary variables that represent a state of an environment. Intermediary variables are also known as intervening or mediating variables, and are defined by explaining a relation or provide a causal link between other variables. Status nodes may be discrete quantities, continuously variable quantities, Boolean, or the like. A single set of status node values in a model correspond to a single environment, as detailed below. An example of a status node in a warfare context is “high tension atmosphere on Korean peninsula.”

In FIG. 4, status nodes include “high gas prices,” “gas taxes,” “consumer desire to be green,” “electric prices,” “gas prices,” “number of gas stations,” and “number of electric car charging stations.” The status nodes of FIG. 4 use a combination of value types. For example, Boolean values include gas prices=1 (high), high gas taxes=1 (true), high electric prices=−1 (false). Discrete quantity node values shown in FIG. 4 include consumer desire to be green=−1 (low), number of gas stations=1 (high), number of electric car charging stations=−1 (low).

Causal simulation models may also include exploratory status nodes. Unlike status nodes that are part of an environment, an exploratory status node's initial value can be varied at the start of each model processing run by sampling from a distribution. This enables analysts to understand how the robustness of different courses of action may vary under different initial conditions. The values for exploratory status nodes can be continuous or discrete quantities. In FIG. 4, exploratory status nodes include “electric car convenience,” “gas car convenience,” “electric car ownership costs,” “gas car ownership costs,” and the like.

Choice Nodes are independent variables that may represent, for example, decisions or policies that can be implemented as part of a course of action. Choice nodes are typically Boolean in nature but can be discrete quantities or continuously variable quantity. An example of a choice node in a warfare context is, “implement economic sanctions against North Korea.” An example of a choice node from FIG. 4 includes “investments in battery research and development,” “favorable electric tax credits,” “investments in battery R&D,” and “investments in gas engine efficiency research and development.” In FIG. 4, the choice nodes have Boolean values.

A digital computer simulation may include a multi-outcome node evaluation that is used to understand a change (e.g., increase or decrease) in multiple outcomes under different conditions. Each outcome can be computed and plotted for multiple distributions. Using FIG. 4 as an example, an ideal scenario may be defined where a number of electric cars consumers purchase=1 and a number of gas cars consumer purchase=0. A composite outcome score can be defined as the Euclidean distance from the ideal scenario. Or, if the outcomes are mutually exclusive hypotheses (i.e., exactly one or neither is true), a different outcome function can be defined where outcome nodes are normalized to sum to 1 and outcomes are partitioned into cases. A case can then be classified after a run and the distribution of cases can be plotted. For example, cases may include “outcome 1 increases the same as outcome 2” (outcomes 1 and 2 are equally likely); “outcome 1 increases more than outcome 2” (1 is more likely than 2); and “outcome 2 increases more than outcome 1” (2 is more likely than 1).

As introduced above, nodes can be initialized prior to model processing runs. Outcome nodes are typically computed from model processing runs to determine a probability of outcomes of interest, as an outcome space. Accordingly, an outcome node may be initialized to 0 by default or set to a non-zero value if a current state of the concept represented by the outcome node is known. Outcome nodes are usually not initialized by sampling from a distribution of values.

Status nodes may be initialized to values sampled from a distribution when current states of the concepts represented by the status nodes are unknown or being explored through a simulation. Parameters for the sampling distribution may be specified to influence which values can be included from the sampling. In some embodiments, a status node can change or be held constant during a model processing run. As noted above, a permutation of a set of status nodes is referred to as an “environment” (Ev). A single environment includes a single set of status nodes. Multiple environments include multiple sets of status nodes, which represent different states being explored.

Choice nodes may be initialized, and are typically held constant during model processing runs. In some embodiments, a user may specify that specific choice nodes are allowed to change. A permutation of choice node values is referred to as an “option” (O). A single option includes a single set of choice node values, and multiple options include multiple sets of choice node values. In a digital computer simulation, a user may specify to generate all permutations of choice node values that correspond to all options. In this “all options” case, the system may inform the user of how many options there are before conducting model processing runs, to minimize inefficiencies by allowing the user to select a subset of options for model processing runs. In some embodiments, initial choice node values are designated by a user or the system may generate multiple choice node value permutations.

In FIG. 4, four options may include, for example, option 1: implement favorable electric car tax credits (=1), investments in battery R&D (=1), and investments in gas engine efficiency R&D (=1); option 2: only implement favorable electric car tax credits and investments in battery R&D; option 3: only implement investments in gas engine efficiency R&D; and option 4: only implement investments in battery R&D and investments in gas engine efficiency R&D.

Causal simulation models may also include clamped nodes. Clamped nodes are reset to their initial values at the start of each model processing run. These nodes represent continuing conditions whose values remain unchanged during model processing runs. In FIG. 4, for example, clamped nodes includes “gas taxes,” “electric prices,” and “number of gas stations.”

Edges represent associations between nodes. Edge weights can represent the causal nature of the associations between the nodes. The sign of an edge weight defines a type of causality, and the magnitude of the edge weight defines the strength of the causal relationship. That is, a positive edge weight indicates direct causality and a negative edge weight indicates inverse causality. The magnitude of the edge weight indicates how much, relative to its range, that a change in one node will affect a change in its associated node. An edge weight of 0 indicates that there is no causal relationship between nodes. For example, FIG. 2 shows an edge from nodes F to H that has a weight of +2 in a range [−10, +10], which indicates that an increase in F causes a small increase in H. FIG. 2 also shows an edge from nodes G to D with an edge weight of −4 in a range [−10, +10], which indicates that G causes a larger decrease in D. Edge weights can also be initialized, and are generally held constant during model processing runs. In some embodiments, some edge weights can change during model processing runs.

A causal simulation model is then processed with initial node values and edge weights. A single model processing run consists of one or more iterations, and it is complete when outcome node values reach a steady state (e.g., values at iteration t+1 are equivalent to the values at iteration t), or when node values cycle among a fixed pattern of values (i.e., converge). At each iteration, each node value can be updated from its initial value or value from the previous iteration. To compute the updated value of a node, an aggregation mathematical function aggregates the effects of each incoming adjacent node based on the value of the incoming adjacent node and the weight of the edge. In some embodiments, the mathematical function may simply sum up the value of each adjacent node multiplied by its weight, or it may employ another strategy to compute the updated node value. A thresholding function can be used after an iteration to ensure that node values remain in their proper value ranges, to prevent values from diverging. In some embodiments, a default thresholding function is used or a user may specify a different thresholding function. An outcome space of iterations of model processing runs (i.e., a completed simulation) includes final values for each outcome node, or, when there is a fixed cycle pattern, average outcome node values.

### D. Crowdsourcing

Crowdsourcing can be used to obtain information about one or more causal descriptive models by soliciting feedback over network 106 from two or more paid or unpaid crowd members 108. Crowd members 108 include people operating devices that communicate with portal 102 over network 106. Feedback may be solicited by simulator 104 from crowd members 108 over network 106 via an online user interface provided by portal 102.

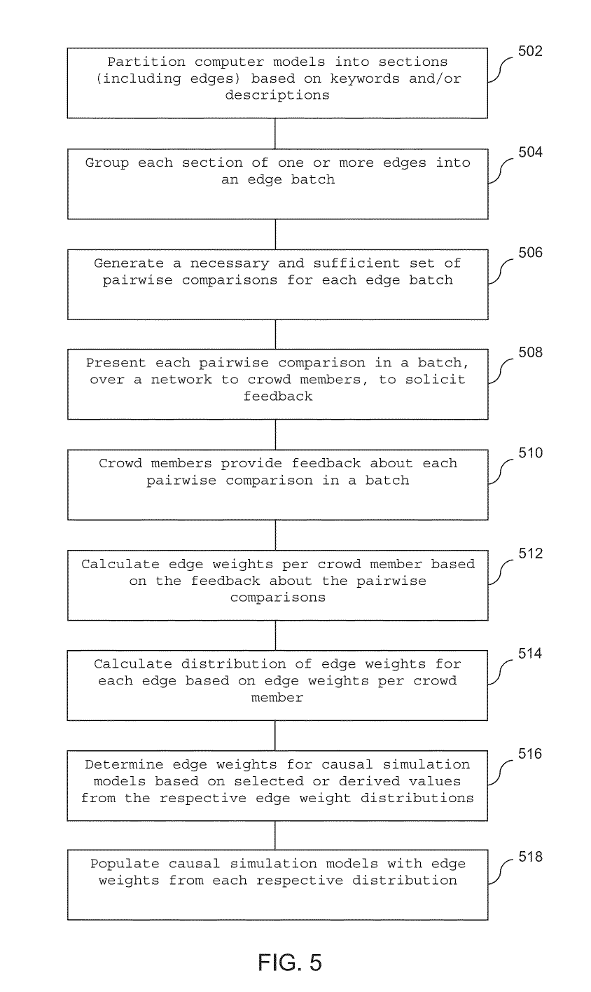

FIG. 5 shows a flowchart illustrating a process for calculating edge weights. In step 502, each of the one or more causal descriptive models from step 312 is partitioned into one or more sections. Each section includes a group of one or more edges and comprises an edge batch, as shown in step 504. Each section may also include a focus question or description and a set of keywords describing the section. In step 506, a group of one or more pairwise comparisons is generated for each edge batch as detailed below. This can be referred to as a pairwise comparison batch. If desired, a maximum pairwise comparison batch size can be specified, or all comparisons for each section, or the entire model, can be included in a single batch of comparisons.

Pairwise comparisons may be determined by using a pairwise comparison generation algorithm running on simulator 104. The algorithm can use a set of heuristics to generate a necessary and sufficient set of pairwise comparisons that allow for a numerical computation of edge weights. The algorithm accepts as input one or more edges and the causal descriptive models that contain the edges, and outputs a batch of pairwise comparisons. Each batch of pairwise comparisons can form a connected graph. If there are two or more relationships with the same weight (e.g., “High”), there is at least one comparison with relationships that have that weight. Each relationship is included in at least one pairwise comparison. For each node, most or all pairs of incoming and outgoing relationships are included in at least one comparison.

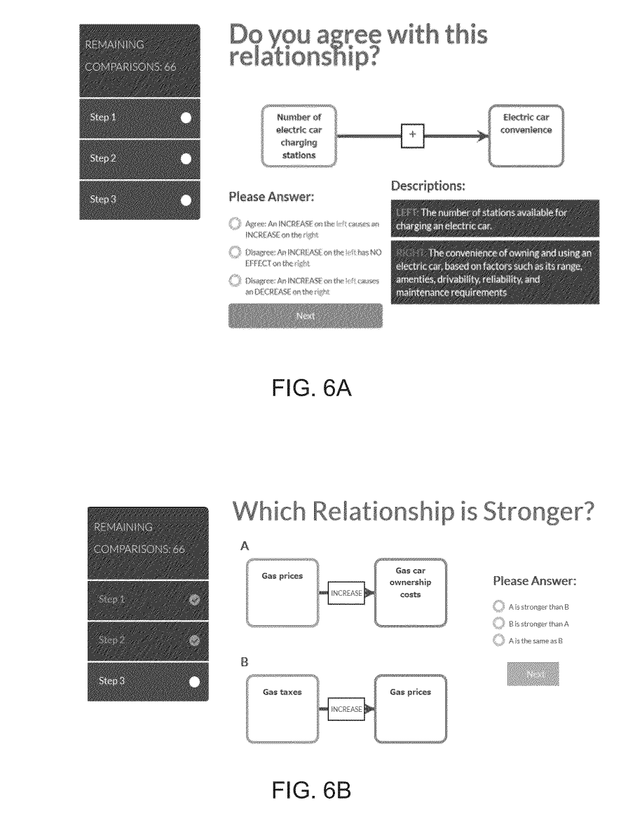

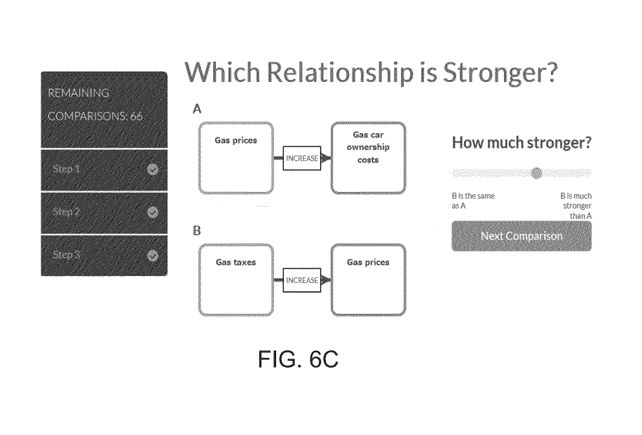

In step 508, each batch of pairwise comparisons is distributed by portal 102 to crowd members 108 over network 106. The pairwise comparisons may be rendered on a user interface provided by portal 102 to solicit feedback. An exemplary user interface is shown in FIGS. 6A-6C, and described below. In step 510, crowd members complete one or more pairwise comparison batches by providing feedback for each pairwise comparison. In step 512, edge weights are computed for each crowd member based on the feedback they provided in the pairwise comparisons, as detailed below.

An edge weight algorithm can be used to generate edge weights based on feedback received from crowdsourcing. A single pairwise comparison input to the algorithm contains two edges and feedback indicates, among other things, which edge is stronger and by how much. The output is a numeric edge weight. These inputs and outputs may correspond to floating point values in a range [0, 1]. In some embodiments, a graph-based traversal approach can be used to compute weights when feedback about a set of pairwise comparisons is not complete (i.e., when a crowd member did not provide feedback on all comparisons in a batch). The graph-based traversal approach identifies the largest connected graph formed by the pairwise comparisons that the crowd member provided, and computes weights for edges not contained in a provided comparison by finding paths that connect those edges through a comparison that was provided. In step 514, a distribution of edge weights for each edge is calculated based on the individual edge weights computed from each crowd member 108. In step 516, edge weights are determined for the edges of the one or more causal simulation models, as values selected or derived from their respective edge weight distributions. In step 518, the one or more causal simulation models are populated with the edge weights.

Thus, crowd members 108 are asked to rate one or more of pairwise comparisons, and edge weights are calculated based on input from crowd members 108 about the pairwise comparisons. For example, edge weights may be calculated by using an average or sampled value from a distribution of values provided through crowdsourcing. In some embodiments, these calculated edge weights can change or remain constant during model processing runs. For each edge weight, a user operating simulator 104 can specify whether to use an average crowd-sourced value, the crowd-sourced distribution, a fixed value, another distribution, or the like. Parameters, such as thresholds, for sampling from a distribution may be specified.

Edge weights are thus defined based on information received, over network 106 via crowdsourcing, by soliciting feedback from crowd members 108 about pairwise comparisons. In some embodiments, a batch of pairwise comparisons are made available to crowd members 108 through portal 102 via a website with a unique URL. The website may include access to one or more causal descriptive models stored in one or more databases accessible to simulator 104. In some embodiments, a crowd member can select a model or sections therefrom, and portal 102 can send a corresponding batch of pairwise comparisons to the crowd member. The crowd member can later choose to contribute to a batch for a different model and/or another section for the same model. In some embodiments, crowd members can view their past pairwise comparisons and revise them if the model is active.

In some embodiments, crowd members 108 are registered with the website to contribute feedback about the causal descriptive models. As detailed above, crowd members 108 may register with the website by providing personally identifiable information. Users may also be prompted to provide keywords or credentials related to their type and level of expertise. Portal 102 may limit access by registered crowd members 108 to causal descriptive models that are within their scope of expertise. For example, crowd members can only browse or search for causal descriptive models that include focus questions and keywords that match their expertise. In some embodiments, registered crowd members 108 are solicited for input about subjects related to their expertise. In some embodiments, a crowd member seeking to generate a digital computer simulation can solicit input from registered experts, based on keywords related to their expertise.

FIGS. 6A-6B shows examples of different display screens of a user interface provided by portal 102 to solicit feedback from crowd members 108, which is used to determine edge weights for a causal descriptive model. In FIG. 6A, a crowd member is presented a graph that represents a first relationship. The first relationship corresponds to a first edge between two nodes. The crowd member is provided with a description of the nodes and asked to select between several options about which causal relationship best matches the relationship between the nodes. A crowd member selects an option, and clicks the next button to move to the next display screen. The next display screen (not shown) includes a graph that represents a second relationship (corresponding to a second edge) and similarly asks the crowd member to respond by selecting an option that best represents a causal relationship between two nodes. After selecting an option, and clicking the next button, the display screen of FIG. 6B is rendered. This completes the first step for a pairwise comparison.

In FIG. 6B, the crowd member is asked to indicate whether the first edge is stronger than the second edge, the second edge is stronger than the first edge, or the edges have the same strength. The crowd member selects an option, and clicks a next button to move to display screen of FIG. 6C. This completes the second step for a pairwise comparison.

In FIG. 6C, if the crowd member indicates that the first and second edges are not of the same strength, the crowd member is asked to indicate how much stronger one is over the other. The crowd member can specify this value by moving a slide bar in a direction to show the relative strength of the causal relationship. This completes the third and final step of a pairwise comparison.

The crowd member then clicks the next comparison button to move to another pairwise comparison. Steps 1-3 are iterated over the total number of pairwise comparisons in the batch.

### E. Analysis and Visualization

The number of model processing runs required to generate an outcome space may vary according to different parameters. These parameters include options (O), environments (Eᵥ), number of permutations of exploratory status node initial values (Sₙ). For Boolean and discrete status nodes, there are 3 initial values (e.g., −1, 0 and +1). For continuously variable status nodes, the number of initial values depends on the distribution and sampling strategy. A number of permutations of edge weights (Eₙ) may be one value for single-value edges or multiple values depending on the distribution and sampling strategy for sampled edges. Thus, a total number of model processing runs may equal O*Eᵥ*Sₙ*Eₙ.

In some embodiments, multiple model processing runs are iterated to generate an outcome space. A distribution of outcome node values may be generated for each permutation of an option and an environment. For example, a total of O*Eᵥ distributions can be generated. For each option-environment permutation (Oₓ-Eᵥₓ, an outcome node distribution is generated by varying initial node values and edge weights in respective model processing runs. The subscript x in Ox-Eᵥₓ refers to an option or environment number.

Variations in outcome spaces may be generated in different ways. For example, a Monte-Carlo method may generate each variation by sampling from distributions of nodes and edge weights that have sampling distributions. In some embodiments, each sampling is independent from another. The number of variations (Nᵥ) required to sufficiently sample an outcome space may depend on a number of nodes and edges that have sampling distributions, the value ranges for those distributions, and the distribution sampling strategy employed. In some embodiments, a Cartesian Product method is used to generate every possible variation. For nodes and edges that have sampling distributions, every value in each sampling distribution can be sampled. In some embodiments, three values (−1, 0, 1) or 11 values (e.g., −1, −0.8, −0.6, −0.4, −0.2, 0, 0.2, 0.4. 0.6, 0.8, 1) may be sufficient to generate a reliable outcome space.

An optimal number of variations that is computationally feasible should be determined. For example, for each Oₓ-Eᵥₓ, the total number of variations is Sₙ*Eₙ, where Sₙ is a number of permutations of exploratory status node initial values, and Eₙ is the number of permutations of edge weights. The total number of model processing runs necessary to generate a suitable outcome space can be O*Eᵥ*Nᵥ, where Nᵥ is the number of variations of initial node and edge values.

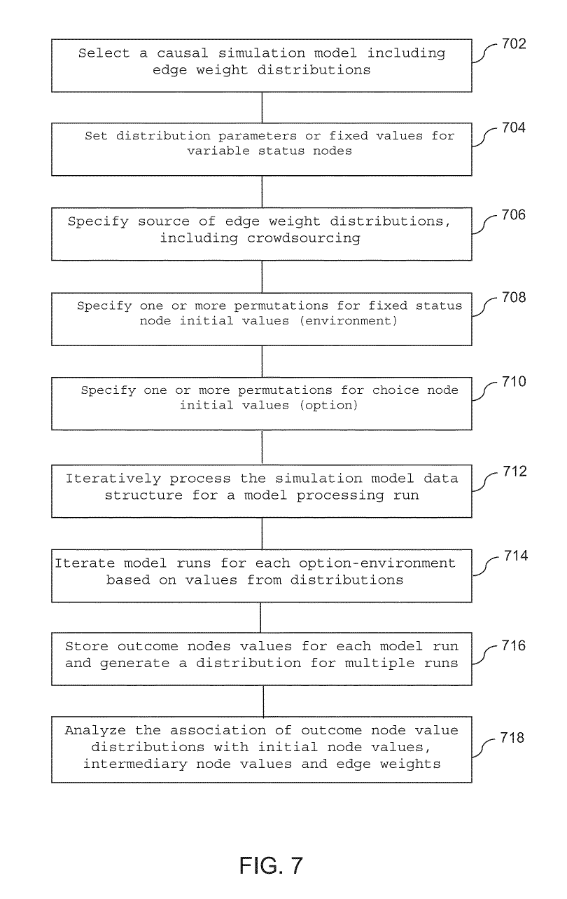

FIG. 7 shows a flowchart illustrating a process for calculating an outcome space. In step 702, an analyst selects for analysis a causal simulation model including edge weight distributions. In step 704, the analyst specifies initial distribution parameters or fixed values for status nodes. In step 706, the analyst specifies whether to use crowd sourced edge weight distributions or another edge weight distribution for each edge of the causal simulation model. In step 708, the analyst specifies one or more fixed initial status node values, which reflect an environment. In step 710, the analyst specifies one or more permutations of initial choice node values, which reflect options. In step 712, the disclosed system computes a model processing run for an option-environment permutation. In some embodiments, steps 704 through 710 can be completed in any order, and are iteratively completed for step 712.

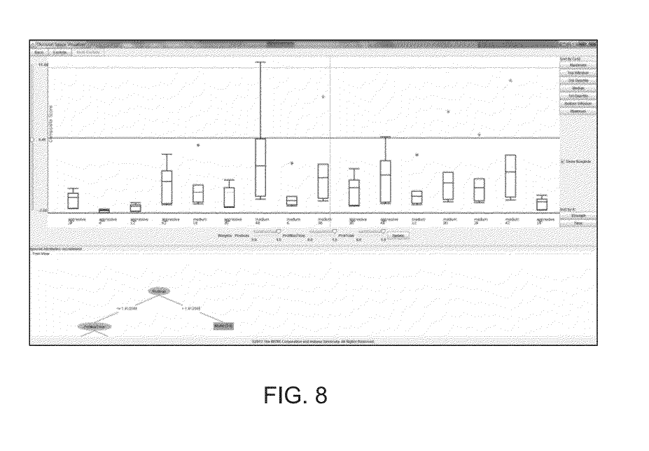

In step 714, the system executes a model multiple times for each option-environment permutation. Exploratory status nodes and edges are initialized by sampling from their distributions, or by using specified fixed values, for each model processing run. In step 716, the final outcome node values for each model processing run are stored in memory or on data storage media at simulator 104, for example. A distribution of outcome node values is generated for model processing runs for each option-environment permutation. Finally, in step 718, the distribution of outcome node values (e.g., the decision space) can be explored by using a visualization tool, an example of which is shown in FIG. 8. This includes analyzing the association of outcome node value distributions with initial node values, intermediary node values and edge weights. An estimated run time can be calculated based on a required number of model processing runs. A single model processing run consists of one or more processing iterations, as described above. Multiple outcome spaces can be generated from multiple model processing runs for multiple scenarios.

An outcome space can be viewed and explored using a visualization tool referred to herein as a Visualizer. In some embodiments, the Visualizer is a standalone JAVA application. FIG. 8 illustrates an exemplary user interface used for exploring an outcome space. For causal simulation models, the X-axis can correspond to each permutation of each course-of-action option, and the Y-axis can correspond to the value of an outcome node. For multiple outcome nodes, the Y-axis includes node values or a weighted composite value. In some embodiments, the Visualizer may input a CSV file that contains structured outcome space data. In order to associate each outcome in the space with initial node values and data derived from analyses, the first column in the file may be a unique ID that the system uses to identify every outcome in an outcome space plot. The remaining columns may define values for edge weights, initial node values, and outcome node values for each run.

As explained below, in some embodiments, a computer-generated depiction of a decision space may display the range of outcomes for each potential decision option under various plausible environmental conditions. This visualization approach allows a decision maker to actually see relationships between options that are otherwise obscured, rather than requiring to mentally simulate each one. In essence, the disclosed systems and methods, elicit mental causal descriptive models from people, and then transform them into computer processable causal simulation models, which allows for offloading the simulation modeling burden from people to the computer. Consequently, by returning choice to a perceptual comprehension process, this enables decision makers to apply their more powerful visual, pattern matching capabilities, rather than their more limited capacities, for mental simulation.

The systems and methods described herein could be used for different use cases. For example, outcome spaces could include, but are not limited to, policy analysis, event forecasting, event classification, information gain analysis, and the like. For a policy analysis, a set of choice node permutations correspond to a policy that can be used to examine an outcome space for each policy. For event forecasting, permutations of choice nodes and environments are generated to explore an outcome space. Probabilities are assigned to each environment and probabilities of each outcome are derived from the forecasting.

For event classification, status nodes are configured as an environment changes in real time to determine the probability of being in various world states. For example, the probability that a current event may be a terrorist attack compared to a routine incident. For information gain analysis, one or more status nodes are selected and initialized to different values representing different information states at different times (t₁ . . . tₙ), or the status nodes are permutated such that more is known at each permutation. The system computes an outcome space for each time step and assess whether outcome spaces changed enough to justify the collection of additional information.

The disclosed systems and methods enable a user to select the outcomes that are satisfactory, better than satisfactory, and worse than satisfactory for a single variable and view the conditions that would lead to those outcomes. The user can select the conditions for a single variable or multiple variables, and view the outcomes to which these conditions lead. The disclosed systems and methods can display, upon user request, conditions associated with at least two individual (user-specified) outcomes simultaneously. A visual or textual summary of the outcomes that result from the selected conditions is provided in a manner that is comprehensible to the intended set of users.

Providing a visualization of a decision space improves decision-making accuracy, speed, and confidence. Supplying this decision space yields the first level of variable awareness, enabling decision makers to visually identify the most robust variable that will provide satisfactory outcomes across the broadest swath of plausible futures. The disclosed systems and methods enable investigating a deeper level of variable awareness, comprehending the conditions that tend to lead to better or worse outcomes for the variables, which can result from interactive data mining of the decision-space. Data mining techniques are used to provide enhanced variable awareness. This interactive decision support system combines interactive data mining techniques with a frequency-formatted decision space visualization, as described below.

Data mining is an analysis step used to discover knowledge from data. A data mining tool can be used on a simulation to determine which conditions lead to better or worse outcomes. Expert judgment can define criteria that delimit good versus bad outcomes from the simulation. An algorithm can produce a hierarchical classifier tree that starts with one node representing a scenario attribute that provides the greatest discrimination among outcomes. Successively lower level tree branches either lead to another discriminatory factor or to a leaf node. A leaf node in the tree represents a set of outcomes that occur under a set of conditions that are described by the discrimination path traversed through the tree to get to a node.

In some embodiments, this tree structure forms the underpinnings that are used to present results. The results from this type of data mining can be used for pre-planning and in real-time event monitoring. To be used in real time, the classifier tree can be translated into a playbook whereby a decision maker can assess a situation, find conditions in the playbook and see what is recommend to obtain good outcomes.

The disclosed systems and methods enable users to see which variables have more robust outcomes. Robust variables are defined as variables that have possible outcomes that are acceptable to users over a broad range of cases developed under many different sets of conditions. To aid understanding decision choices, users will want to find variables that will have a majority of good, or at least satisfactory, outcomes. For example, a variable may have a distribution of outcomes, with one outcome being very costly and the rest of the cases having lower costs. If the high-cost case is due to a preventable circumstance, then, after modifying the variable to prevent that outcome, all of the remaining outcomes may have satisfactory costs and therefore the variable would be much more desirable. Thus there is value in being able to see the range of individual outcomes and their conditions, so that options can be amended to be more robust

The interactive visualizations generated through digital computer processing of causal simulation models lead to better comprehension of interactions, which potentially enables users to modify options to develop more robust alternatives. In other words, the systems and methods disclosed herein can provide “second and third level option awareness.” First level option awareness enables users to perceive relative robustness between alternative options. Second level option awareness enables users to discriminate between those factors that lead to better verses worse outcomes for each option. Third level option awareness enables a projection of these underlying relationships to create adjusted or new options. For example, persons with third level option awareness understand factors driving better or worse outcomes to the extent that they can take steps to minimize factors that tend to lead to bad outcomes and maximize factors that lead to good outcomes, thereby yielding improved options.

The disclosed systems and methods allow users to have adequate support for exploring the outcomes and the conditions underlying them. Decision makers can start with variable outcomes and look at the conditions underlying them. The decision maker may want to take this approach to see what conditions may be causing particularly good or bad outcomes. Decision makers can also start with the conditions and see what outcomes will result from applying those conditions. This approach may be helpful when a decision maker is reasonably sure that certain conditions will occur, so he or she may want to look at only those outcomes that correspond to the likely conditions. In this way, a decision maker can choose the variable whose outcomes are all at least satisfactory under the expected conditions.

Decision makers may want to take either of the following approaches when looking at one or multiple variables. The conditions that yield good or bad outcomes may differ between variables. Those variables whose conditions can be shaped are preferable. Therefore the decision maker will explore good/bad outcomes one variable at a time. In some embodiments, viewing multiple variables may be of interest when trying to determine the conditions that lead to similar outcomes across multiple variables.

In some embodiments, each model processing run can be scored according to a multi-attributed utility function. For example, runs can be scored using a variety of cost metrics such as property damage, casualties and opportunity costs. The scoring can be weighted and combined to reflect values emphasized by decision makers. Alternatively, each score can be normalized to a common scale (e.g., z-scores) but not combined, and then plotted to compare components. Different combinations of variables over multiple model processing runs can result in a range of outcomes associated with each set of options. The results can be displayed in a frequency format that depicts all values of the runs in a frequency distribution for each option. When scoring components are not combined, a value could be plotted for each component of each run, which could be color-coded to facilitate comparing costs among components. For example, z-scores for lives lost and for property damage under one option could be compared with each other and with those individual components under another option.

In some embodiments, personalized models can be generated to reflect an individual's own network of beliefs regarding some event, action, or entity. Responses from individuals can be viewed as specific, varied instantiations of models that are used to form a causal simulation model. The models can be mined to identify relationships between people's beliefs and the outcomes that they expect from actions or events. Data at an individual level could enable better understanding among collaborative decision makers, and enable targeted communications based on specific individual variations of a model. In some embodiments, a social media application can enable users to tailor a causal descriptive model to match their network of beliefs. A graphical evaluative feedback space could then enable real-time views of how the model compares to social groups, or exchange information that is tailored to others' models. Collecting information from users to create models through a widespread social media venue (i.e., crowdsourcing), and visualizing this data to enhance collaboration and targeted communication, constitutes a unique synthesis of tested sociocultural research processes and new technological capabilities.

The embodiments described herein are not an exhaustive representation of possible configurations or uses. Persons skilled in the art would understand that these concepts could be applied to additional systems, devices and methods. The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications, without departing from the spirit and scope of the invention. Thus, this invention is not intended to be limited to the embodiments shown, but is to be accorded the widest scope consistent with the principles and features disclosed herein.

1. A computer implemented method for creating a causal computer simulation, comprising:
creating one or more causal descriptive models, each causal descriptive model comprising a plurality of nodes associated with a plurality of weights;
generating, using one or more processors, one or more groups comprising two or more of the plurality of nodes;
receiving, over a network, feedback from a plurality of users about each group;
determining a plurality of values for the plurality of weights based on the feedback; and
processing the one or more causal descriptive models to create a causal computer simulation.

2. The computer implemented method of claim 1, wherein each causal descriptive model comprises a plurality of nodes associated with a plurality of only qualitative weights, and the plurality of values determined for the plurality of weights based on the feedback are quantitative values.

3. The computer implemented method of claim 1, comprising determining the plurality of values by crowdsourcing with the plurality of users.

4. The computer implemented method of claim 3, wherein each of the plurality of users is registered with a website that accepts the feedback.

5. The computer implemented method of claim 4, wherein registering a user with the website comprises storing information in a memory received from the user that comprises keywords and credentials that indicate a type and level of expertise for the user.

6. The computer implemented method of claim 5, comprising soliciting feedback for a group, over a network, from a registered user with a type and level of expertise that is equal to or greater than a type and level of expertise associated with the group.

7. The computer implemented method of claim 5, wherein a registered user is permitted to provide feedback for a group only when the registered user has a type and level of expertise that is equal to or greater than a type and level of expertise associated with the group or with at least one of the causal descriptive models.

8. The computer implemented method of claim 3, comprising generating a distribution of values for each of the plurality of weights based on the feedback received from the crowdsourcing.

9. The computer implemented method of claim 8, comprising designating a value for each of the plurality of weights by sampling from the respective distribution of values for each of the respective weights.

10. The computer implemented method of claim 8, comprising designating a value for each of the plurality of weights by calculating an average value from the respective distribution of values for each of the respective weights.

11. The computer implemented method of claim 1, comprising:
setting one or more initial values for at least a portion of the plurality of nodes; and
changing the one or more initial values during the causal computer simulation processing.

12. The computer implemented method of claim 11, comprising:
iterating a plurality of model processing runs of the one or more causal descriptive models during the causal computer simulation processing until values for the at least a portion of the plurality of nodes are within a predetermined threshold difference between N+1 and N iterations.

13. The computer implemented method of claim 12, wherein the threshold is zero.

14. The computer implemented method of claim 11, comprising iterating a plurality of model processing runs of the one or more causal descriptive models during the causal computer simulation processing until values for the at least a portion of the plurality of nodes converge.

15. The computer implemented method of claim 1, wherein each of the plurality of nodes is associated with a plurality of keywords and two or more nodes are included in a group when they are associated with at least one common keyword.

16. The computer implemented method of claim 15, wherein each of the two or more groups consists of two nodes.

17. An apparatus for creating a digital computer simulation, comprising:
one or more processors configured to determine two or more groups that each comprise two or more nodes that are extracted from one or more causal descriptive models and associated with a plurality of weights;
a network interface configured to receive, over a network, feedback about each group from a plurality of users; and
a memory configured to store a plurality of values determined for the plurality of weights from the feedback,
the one or more processors algorithmically process the one or more causal descriptive models to create a digital computer simulation.

18. The apparatus of claim 17, wherein the one or more processors generate a distribution of values for each of the plurality of weights based on feedback received by crowdsourcing with the plurality of users.

19. The apparatus of claim 18, wherein the one or more processors designate a value for each of the plurality of weights by sampling from the respective distribution of values for each of the respective weights.

20. The apparatus of claim 18, wherein the one or more processors designate a value for each of the plurality of weights by calculating an average value from the respective distribution of values for each of the respective weights.

21. A server system for creating a digital computer simulation, comprising:
a network interface configured to receive, over a network, feedback from a plurality of users about a plurality of causal relationship between a plurality of nodes in one or more causal descriptive models; and
one or more processors configured to calculate a plurality of values associated with the plurality of causal relationships and process the one or more causal descriptive models to create a digital computer simulation.

22. The server system of claim 21, comprising one or more memories configured to store registration information for each of the plurality of users that comprises keywords and credentials that indicate a type and level of expertise for each user.

23. The server system of claim 22, wherein a registered user is permitted to provide feedback for a group only when the registered user has a type and level of expertise that is equal to or greater than a type and level of expertise associated with the group.

24. The server system of claim 22, wherein the feedback is solicited, over the network, for a group from a registered user with a type and level of expertise that is equal to or greater than a type and level of expertise associated with the group.
